(19) United States
(12) Patent Application Publication
(10) Pub. No.: US 2026/0113585 A1
(43) Pub. Date: Apr. 23, 2026

(54) DIRECTIONAL AUDIO SOURCES PRESENTED IN 3D AUDIO SPACE

(71) Applicant: Sony Interactive Entertainment Inc., Tokyo (JP)

(72) Inventors: Michael Harrison Prosinski, Burlingame, CA (US); Brandon Sangston, Alhambra, CA (US)

(21) Appl. No.: 18/920,619

(22) Filed: Oct. 18, 2024

(51) Int. Cl. H04S 7/00; H04R 5/02; H04R 29/00

(52) U.S. Cl. CPC H04S 7/301; H04R 5/02; H04R 29/001

(57) ABSTRACT

A method including defining a three dimensional (3D) audio space used by an audio system configured to provide localized sound with directionality in the 3D audio space. The method including localizing gaming audio from a game play of a video game within the 3D audio space using the audio system. The method including representing a first audio source providing audio of a first message type with an icon movable through a visual representation of the 3D audio space via a user interface. The method including detecting movement of the icon to a source location in the visual representation of the 3D audio space via the user interface. The method including assigning the source location to the first audio source based on a selection of the source location via the user interface. The method including projecting one or more audio messages of the first audio source from the source location using the audio system.

### TECHNICAL FIELD

The present disclosure is related to providing directional audio in a three dimensional audio space for corresponding audio sources. In that manner, different audio sources that are spatially separated can be distinguishable from each other, and from an underlying application, such as a video game.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

Often, in addition to the audio generated for a game play of a video game, a user may be listening to additional audio sources. For example, the user may be participating in a chat audio source with other participants. The audio from the chat audio source is mixed with the gaming audio, such as placing the audio from the chat audio source indiscriminately over the audio from the game play. Further, the user may have more than one audio sources open during the game play, each of which is placed on top of the gaming audio. As a result, because the audio from the one or more audio sources are indiscriminately placed on top of the gaming audio, there may be audio conflicts between the audio sources and/or the gaming audio. Because of the conflicting audio, the user may be unable to clearly hear the audio from one or more audio sources, or may be unable to distinguish audio from one audio source from another audio source, or audio from one audio source from the gaming audio.

It is in this context that embodiments of the disclosure arise.

### SUMMARY

Embodiments of the present disclosure relate to providing directional audio in a three dimensional (3D) audio space for each of one or more audio sources. The audio sources may provide additional audio to audio from an application, such as a video game. In that manner, the audio from the audio sources are spatially separated from each other and/or the audio from the application. A user may actively place each audio source in different source location in the 3D audio space via a user interface. In addition, the audio sources may be automatically placed in different source locations to avoid conflicting audio. In one implementation, artificial intelligence is implemented to learn where the audio sources should be placed to avoid conflicts between the audio sources, and may learn user preferences on where to locate the source of audio sources in the 3D audio space.

In one embodiment, a method is disclosed. The method including defining a three dimensional (3D) audio space for use by an audio system configured to provide localized sound with directionality in the 3D audio space. The method including localizing gaming audio from a game play of a video game within the 3D audio space using the audio system.

The method including representing a first audio source providing audio of a first message type with an icon movable through a visual representation of the 3D audio space via a user interface. The method including detecting movement of the icon to a source location in the visual representation of the 3D audio space via the user interface. The method including assigning the source location to the first audio source based on a selection of the source location via the user interface. The method including projecting one or more audio messages of the first audio source from the source location using the audio system.

In still another embodiment, a computer system is disclosed, wherein the computer system includes a processor and memory coupled to the processor and having stored therein instructions that, if executed by the computer system, cause the computer system to execute a method. The method including defining a three dimensional (3D) audio space for use by an audio system configured to provide localized sound with directionality in the 3D audio space. The method including localizing gaming audio from a game play of a video game within the 3D audio space using the audio system. The method including representing a first audio source providing audio of a first message type with an icon movable through a visual representation of the 3D audio space via a user interface. The method including detecting movement of the icon to a source location in the visual representation of the 3D audio space via the user interface.

The method including assigning the source location to the first audio source based on a selection of the source location via the user interface. The method including projecting one or more audio messages of the first audio source from the source location using the audio system.

In another embodiment, a non-transitory computer-readable medium storing a computer program for performing a method is disclosed. The non-transitory computer-readable medium including program instructions for defining a three dimensional (3D) audio space for use by an audio system configured to provide localized sound with directionality in the 3D audio space. The non-transitory computer-readable medium including program instructions for localizing gaming audio from a game play of a video game within the 3D audio space using the audio system. The non-transitory computer-readable medium including program instructions for representing a first audio source providing audio of a first message type with an icon movable through a visual representation of the 3D audio space via a user interface. The non-transitory computer-readable medium including program instructions for detecting movement of the icon to a source location in the visual representation of the 3D audio space via the user interface. The non-transitory computer-readable medium including program instructions for assigning the source location to the first audio source based on a selection of the source location via the user interface. The non-transitory computer-readable medium including program instructions for projecting one or more audio messages of the first audio source from the source location using the audio system.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1A illustrates a system configured for providing directional audio in a three dimensional audio space for corresponding audio sources, in accordance with one embodiment of the present disclosure.

FIG. 1B illustrates a block diagram of an audio source three dimensional (3D) space localizer configured to provide directional audio in a 3D audio space for corresponding audio sources, in accordance with one embodiment of the present disclosure.

FIG. 2 is a flow diagram illustrating a method for providing directional audio in a 3D audio space for corresponding audio sources, in accordance with one embodiment of the present disclosure.

FIG. 3A illustrates a 3D audio space within which one or more audio sources may be assigned to source locations within the audio space, such that directional audio for those audio sources is provided in addition to audio from a video game, in accordance with one embodiment of the present disclosure.

FIG. 3B illustrates a user interface implemented to assign source locations to one or more audio sources in a rectangular boxed representation of a 3D audio space, in accordance with one embodiment of the present disclosure.

FIG. 3C illustrates a user interface implemented to recognize placement and/or movement of a source location of an audio source within a 3D audio space, in accordance with one embodiment of the present disclosure.

FIG. 3D illustrates a user interface implemented for placement and/or movement of source locations of one or more audio sources within a spherical representation of a 3D audio space, in accordance with one embodiment of the present disclosure.

FIG. 3E illustrates localized audio from corresponding window or display locations within a 3D audio space, so that directional audio from a corresponding window or display is aligned with a physical location of the window or display, in accordance with one embodiment of the present disclosure.

FIG. 4A illustrates the assignment of source locations of audio sources within a 3D audio space based on inter-audio channel priorities, in accordance with one embodiment of the present disclosure.

FIG. 4B illustrates the assignment of source locations of communications within an audio source from different entities within a 3D audio space based on intra-audio source priorities, in accordance with one embodiment of the present disclosure.

FIG. 5A is a flow diagram illustrating a method providing directional audio for corresponding audio sources in a 3D audio space that is anchored to a head mounted display (HMD), in accordance with one embodiment of the present disclosure.

FIG. 5B illustrates a source location of an audio source that is fixed in relation to any orientation of the HMD within a physical space, in accordance with one embodiment of the present disclosure.

FIG. 6 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for providing directional audio in a three dimensional (3D) audio space for corresponding audio sources. The 3D audio space may be defined and/or implemented by any 3D audio system, such as systems providing surround sound capabilities, 3D headsets, sound bars, headphones, etc. By providing directionality, spatial separation of audio sources helps a user to distinguish audio from those audio sources (e.g., multi-channel representations, etc.), and/or audio from an underlying application (e.g., video game). The audio sources provide distinct audio content received over different input streams, such as chat, local communication, converted text from a text source, friend audio sources, audio sources of followers, game sound effects, music, music from a streaming service, etc. Without spatial separation, audio from one or more audio sources are indiscriminately mixed with audio from the underlying application. For example, a chat audio source of users on a team, and another audio source providing communications from friends may be mixed with the audio from the underlying application. That is, the user may have one or more audio sources open with the execution of the underlying application that create audio conflicts between the audio from the audio sources and/or the audio from the underlying application. As a result, the user may be unable to clearly hear the audio from one or more audio sources, or may be unable to distinguish audio from one audio source from another audio source, or audio from one audio source from the audio of the underlying application.

On the other hand, embodiments of the present disclosure provide for spatial separation of audio sources that are distinct based on sentiment and message type, within a three dimensional (3D) audio space. The source locations of those audio sources can be assigned automatically or via interaction with a user interface. Also, a source location of a corresponding audio source can be moved from one location to another in the 3D audio space by a user via a user interface, such as by moving a representation of the audio source (e.g., bubble icon) from one location to a desired location within a representation of the 3D audio space via a user interface. In that manner, directional audio from each audio source is presented to the user within the 3D audio space, such that audio of a corresponding audio source originates from a source location in the 3D audio space. As such, the audio from each audio source can be distinguished from each other spatially in order to reduce conflict between audio from two or more audio sources. In addition, audio from one audio source or audio from the underlying application may be modified to reduce audio conflict. For example, the audio emanating from a source location of an audio source may be filtered (e.g., reduced volume, modified, etc.) so that the audio from the audio source is prominently sourced from that location. Further, audio from different audio sources can be assigned priority levels automatically or via user input. For example, audio from a chat is prioritized over personal conversations with friends or local persons. As a result, volume in the different audio sources can be manipulated based on the priority (e.g., increased or decreased based on priority. In addition, source locations of audio sources can be automatically moved around spatially within the 3D audio space based on priorities of those audio sources. Also, source locations of audio sources can be automatically moved around spatially within the 3D audio space based on varying relative priority, such as when one audio source goes inactive another active audio source moves to a higher priority location. In some implementations, artificial intelligence (AI) is configured to learn user preferences for assigning source locations within a 3D audio space to one or more known audio sources, and for learning various rules for reducing conflicts between audio of one or more audio sources and/or audio from an underlying application.

Advantages of the methods and systems, configured for providing directional audio in a 3D audio space for corresponding audio sources, include the spatial separation of audio from different audio sources within a 3D audio space so that the audio is distinguishable to a user. As a further advantage, embodiments of the present disclosure allow for increasing the number of audio sources used within conjunction with an underlying application, while maintaining distinctions between the audio as presented to the user. In that manner, with embodiments of the present disclosure the user is able to personally handle communication from an increased number of multiple audio sources in addition to audio from the underlying application. Another advantage includes the generation and/or implementation of a user interface that is configured to provide a user the ability to assign source locations to audio sources, and to move an audio source from one location to another within the 3D audio space. Also, the user interface may be implemented to allow the user to assign priorities between audio sources to form a priority hierarchy. As another advantage, the spatial separation may be modified and/or maintained automatically (e.g., with predefined rules or AI) or via user input (e.g., user interface interaction) as the content of the underlying application changes, or as priority of audio sources change (e.g., one audio source goes inactive, or as the user modifies priorities to the audio sources, etc.). For example, audio sources may be automatically moved, or via user input, to reduce conflict between audio sources, or with audio from the underlying application, and further spatial separation can be automatically and continually maintained even when the hierarchy of priority changes. A further advantage includes using AI to implement directional audio in a 3D audio space for corresponding audio sources, maintaining spatial separation of audio sources to reduce audio conflicts between the audio sources, assigning priorities to audio sources in an audio source hierarchy, automatically and continually maintaining spatial separation between audio sources even when the hierarchy of priority changes, etc. As such, different audio sources that are spatially separated can be distinguishable from each other to a user, and from an underlying application, such as a video game.

Throughout the specification, the reference to “game” or video game” or “gaming application” or “application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices. ” Moreover, suitable terms introduced above are interchangeable.

With the above general understanding of the various embodiments, example details of the embodiments will now be described with reference to the various drawings.

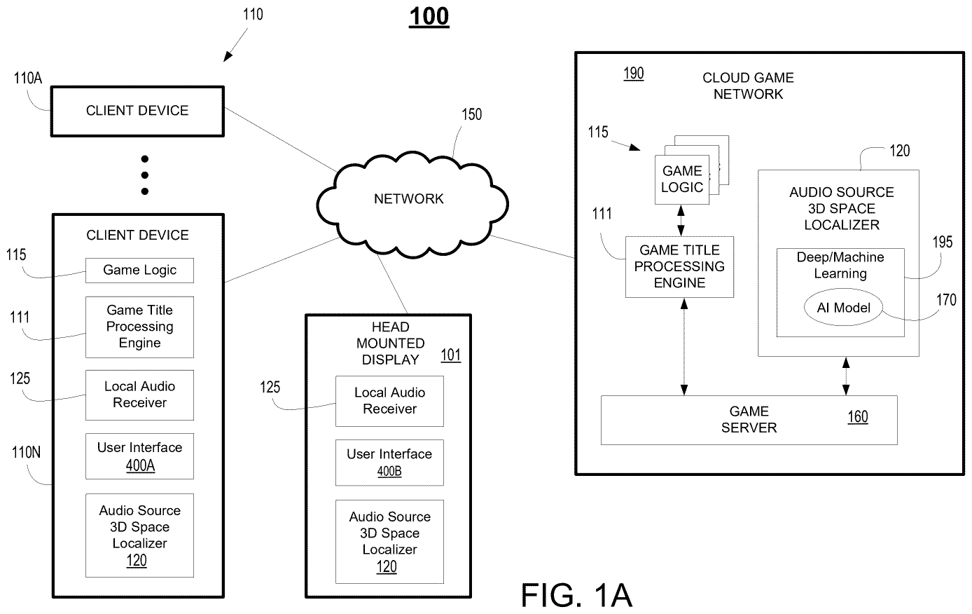

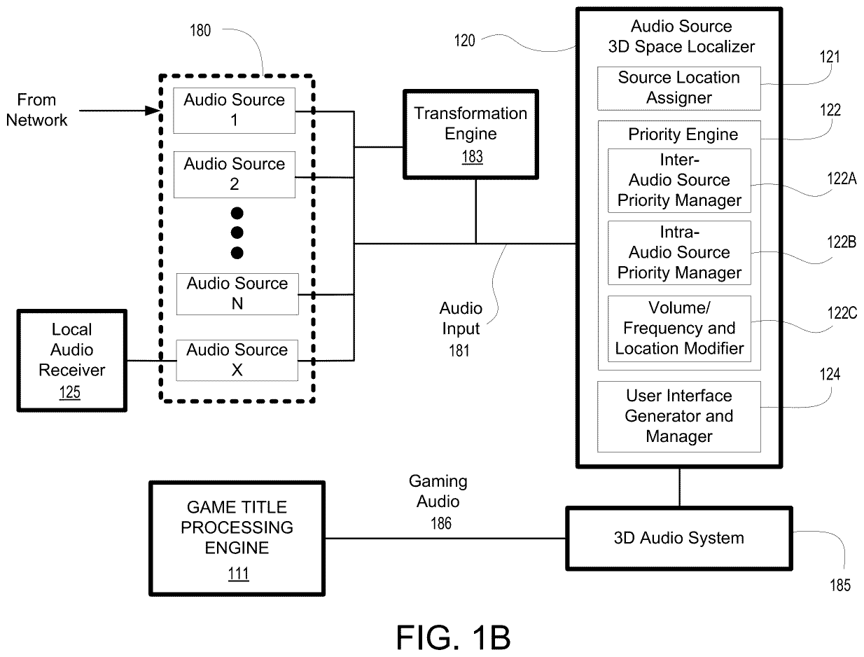

FIG. 1A illustrates a system configured for providing directional audio in a three dimensional audio space for corresponding audio sources, in accordance with one embodiment of the present disclosure. In that manner, different audio sources that are spatially separated in a 3D audio space can be distinguishable from each other, and from a video game.

Throughout the specification, the reference to “an audio source” is meant to include different types//categories/sources of audio, that may be independent of the actual audio format. For example, an audio source may include mono-channel and/or multi-channel representations (e.g., two channels for stereo, eight channels for a 7.1 audio system, thirty-six channels for an Ambisonics system, one-hundred twenty-eight channels for an object-based audio system, etc.). As an illustration, one audio source may include gaming audio including a multi-channel signal from a video game, and another audio source may include voice content (e.g., chat, etc.).

As shown, system 100 may provide gaming over a network 150 for one or more client devices 110 (e.g., 110A through 110N) of one or more users. In particular, system 100 may be configured to enable users to interact with interaction applications, including provide gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device 110 of a corresponding user) or can be executed remotely from a corresponding client device 110 (e.g., acting as a thin client) of the corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc., so that the users in distributed locations participating in a multi-player gaming session can interact with each other in the gaming world or metaverse in real-time. In another capacity, the cloud game network 190 supports multiple users participating in a metaverse.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world or metaverse generated by an application (which may be a video game), some users may be executing an instance of the application locally on a client device (e.g., gaming console, tablet, mobile phone, etc.) to participate in the multi-player session. Other users who do not have the application installed on a selected device or when the selected device is not computationally powerful enough to executing the application may be participating in the multi-player session via a cloud based instance of the application executing at the cloud game network 190.

As shown, the cloud game network 190 includes a game server 160 that provides access to a plurality of video games. Applications played in a corresponding single player and/or multi-player session may be played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances or cloud based instances of the corresponding application. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In single-player or multi-player sessions, instances of an application may be executing locally on a client device 110, head mounted display (HMD) 101, or at the cloud game network 190, or a combination therein. In any case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication audio sources, audio communication, texting, messaging, instant messaging, chat support, game play replay functions, help functions, etc.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

The client devices 110 may be operating using different platforms. For example, one or more client devices may be operating on a first platform (e.g., gaming consoles), and other client devices may be operating a different platform (mobile phones). In still another platform, a platform includes both a client device and game server 160 located at the cloud game network 190 in support of a cloud based instance of an application. As previously described, each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine 111 and game logic 115 (e.g., executable code) that is locally stored for at least some local processing of an application, and may be further utilized for receiving streaming content as generated by the application executing at a server, or for other content provided by back-end server support. In another implementation, client decide 110 acts as a stand-alone system for purposes of executing the application, such as when supporting a game play of a video game.

Client device 110 may include a local audio receiver 125, or receive audio from a local receiver, configured for receiving local audio communications. For example, a user may be located within a room, and receiver 125 may pick up local audio, such as communications from another local person (e.g., within the room or from an adjoining room, external noises generated from the local environment, etc.). The local audio receiver 125 may deliver captured audio to a 3D audio system that is providing 3D audio for the user. In addition, client device 110 may include an audio source 3D space localizer 120 and/or a user interface 400A configured for user interaction with the audio source 3D space localizer. The audio source 3D space localizer 120 is described more fully below.

In another embodiment, client device 110 may be configured as a thin client providing interfacing with a back end server (e.g., game server 160 of cloud game network 190) configured for providing computational functionality (e.g., including game title processing engine 111 executing game logic 115—i.e., executable code—implementing a corresponding application).

Services provided with client devices 110 may also be provided through HMD 101 or headset. In some implementations, the HMD includes at least a CPU, a display and input/output (I/O), and may operate independent of or in conjunction with a client device and/or cloud game network 190. HMD 101 is configured to provide user interaction with a virtual space/environment that is responsive in real-time to the movements of the HMD (as controlled by the user) to provide the sensation to the user of being in the virtual space or metaverse. HMD may be configured with a local audio receiver 125, or receive audio from a local receiver, as described previously. That is, the receiver in the HMD, or local to the HMD, is configured to capture local communication from a communicator located in a physical space within which the 3D audio space is defined, or adjacent to the defined 3D audio space. In addition, HMD 101 may include an audio source 3D space localizer 120 and/or a user interface 400B configured for user interaction with the audio source 3D space localizer. The audio source 3D space localizer 120 is described more fully below.

System 100 includes an audio source 3D space localizer 120 configured to provide directional audio in a three dimensional audio space for corresponding audio sources in combination with 3D audio presented from an underlying application, such as a game play of a video game. In that manner, the audio from the audio sources are spatially separated from each other and/or the audio from the application. Each of the audio sources corresponding with different message types (e.g., chat, friend communication, etc.). The audio source 3D space localizer 120 can be configured to respond to actions by a user, or to perform actions automatically based on rules, or perform actions automatically using AI, or a combination therein. A user interface provides for user interaction with the audio source 3D space localizer 120. The audio source 3D space localizer 120 is configured to define source locations within a 3D audio space for each audio source, and for movement of the source locations. As such, audio from each audio source is broadcast with directionality within the 3D audio space.

Priorities of audio sources, and/or communications within an audio source, may help to assign source locations for audio sources and/or communications of an audio source. Source locations may be dynamically defined and/or modified based on user preference, pre-defined rules, and/or learned rules via AI, or a combination thereof, to provide directional audio from audio sources in order to reduce conflicts between those audio sources. Additional operations may be performed including volume manipulation, filtering, frequency manipulation, elimination of audio from a location, etc.

The audio source 3D space localizer 120 simultaneously spatializes audio in the 3D audio space from multiple audio sources (e.g., chat, social media, game sound effects, streaming music, etc.) that originate from multiple applications (e.g., executing on a system).

That is, the spatialized audio may be generated by or coming from multiple independent programs and/or applications simultaneously executing on a system. For example, a streaming music player (application) could be assigned to one spatial location in the 3D audio space, while chat communication from a social media application may be assigned to another spatial location. Continuing with the example, a separate video game (executing in parallel with another video game) may be assigned to a unique and different spatial location in the 3D audio space. As such, audio source 3D space localizer 120 performs the mixing the spatializing of the audio from the multiple audio sources at an operating system level, rather than at a single application level, in one embodiment. As a further extension, a single application may also perform mixing and spatialization, at an application level, of multiple audio components generated by the application, in another embodiment.

The audio source 3D space localizer 120 may be implemented at the back-end cloud game network. In some implementations, the audio source 3D space localizer 120 may be located at a client device 110 and/or a head mounted display 101, or a combination. That is, the audio source 3D space localizer 120 may be local to a user, such as operating within a client device 110 and/or HMD 101 of the user, or may be remote from the user and operate at a back-end server. For instance, the audio source 3D space localizer 120 may be operating in isolation in the client device 110, wherein the client device may provide interfacing with the user via user interface 400A. Also, the recap engine 120 may be operating in isolation in the HMD 101 of the user, wherein the HMD may provide interfacing with the user via user interface 400B. In another embodiment, the client device 110 and/or the HMD 101 act as a front-end for audio source 3D space localizer 120 operating at the back-end of system 100 (i.e., at the cloud game network 190), wherein the front end provides for interfacing with the user, such as via a corresponding user interface 400A and 400B. In any implementation, the client device 110 and/or the HMD 101 provide interfacing with the user, such as when requesting and/or receiving services provided by the audio source 3D space localizer.

In particular, in some implementations artificial intelligence may be configured to learn user preferences for assigning source locations within a 3D audio space to one or more known audio sources, or for participants within an audio source. Also, AI may be configured to learn various rules for reducing conflicts between audio of one or more audio sources, or audio from participants of an audio source, and/or audio from an underlying application. For example, artificial intelligence is able to identify and/or classify different audio sources (e.g., the source of the communication audio sources), audio from an underlying application, priorities of the audio sources, priorities of communications within an audio source, etc. Further, the artificial intelligence is used to assign different source locations for the audio sources within a 3D audio space to achieve spatial separation; assign different volume levels of the audio sources, or communications within an audio source, or from the underlying application to reduce audio conflict; perform filtering actions for audio from the audio sources, or communications within an audio source, or from the underlying application to reduce conflict; etc. Also, AI may be configured to learn user preferences for assigning source locations to the different audio sources, or source locations to communications within an audio source, assign priorities to audio sources, assign priorities to communications within an audio source, assigning volume levels to audio sources or communications within an audio source, preferred filtering actions on audio sources or communications within an audio source, etc.

The classification and/or identification of audio sources, and the performing of additional operations, including assigning and moving source locations of the audio sources to provide directional audio in 3D audio space for those audio sources, and others, may be performed using artificial intelligence (AI) via an AI layer. For example, the AI layer may be implemented via an AI model 170 as executed by a deep/machine learning engine 195 of the recap engine 120. It is understood that one or more AI models may be implemented, each of which being configured to perform customized classification and/or identification and/or generation of data and/or services used to provide directional audio to different audio sources.

Purely for illustration, the deep/machine learning engine 195 may be configured as a neural network used to train and/or implement the AI model 170, in accordance with one embodiment of the disclosure. Generally, the neural network represents a network of interconnected nodes responding to input (e.g., extracted features) and generating an output related to projection of audio of audio sources and/or communications within an audio source at corresponding source locations. In particular, the AI model 170 is configured to apply rules defining relationships between features and outputs (e.g., assigning source locations, defining user preferences, assigning hierarchy of priorities between audio sources and/or communications within an audio source, assigning source locations and/or volume levels based on the hierarchies, etc.), wherein features may be defined within one or more nodes that are located at one or more hierarchical levels of the AI model 170. The rules link features (as defined by the nodes) between the layers of the hierarchy, such that a given input set of data leads to a particular output (e.g., a key event during game play of a video game) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output.

FIG. 1B illustrates a block diagram of an audio source 3D space localizer 120 configured to provide directional audio in a 3D audio space for corresponding audio sources, in accordance with one embodiment of the present disclosure. The directional audio for corresponding audio sources may be provided in combination with audio 186 from an underlying application, such as gaming audio generated for a game play of a video game executing on game title processing engine 111. In particular, 3D audio system 185 provides 3D audio within a 3D audio space, and includes audio from the plurality of audio sources 180 and audio 186 (e.g., gaming audio). In that manner, the audio from the audio sources are spatially separated from each other and/or the audio 186 from the application. The audio source 3D space localizer 120 can be configured to respond to actions by a user, or to perform actions automatically based on rules, or perform actions automatically using AI, or a combination therein. The audio source 3D space localizer was previously introduced in FIG. 1A.

The 3D audio space may be defined and/or implemented by any 3D audio system, such as systems providing surround sound capabilities, 3D headsets, sound bars, headphones, stereo headphones, etc. For example, the surround sound capabilities may be implemented not only by setups with multiple loudspeakers (e.g., 7.1 audio systems, etc.), but can be provided by headsets and/or headphones that recreate a virtualized 3D audio space.

As shown, the audio source 3D space localizer 120 receives audio input 181. The audio input 181 includes a plurality of audio sources 180 from one or more originating entities. Each of the audio sources correspond with different message types, such as chat services, texting services, social network communication, communication from friends, communication from followers, information provided related to the video game, communication from the local environment, etc.

In some cases, the audio sources (e.g., audio sources 1-N0 are received over a network (e.g., social communications, telecom communications, etc.). In some cases, audio is captured from a local audio receiver 125 and grouped under one audio source (e.g., audio source X). For example, the receiver 125 captures communication from persons located in the same physical environment as a user (e.g., playing a video game). Transformation engine 183 is configured to convert communication from one or more audio sources into an audio format suitable for broadcast via the 3D audio system 185. For example, one audio source may provide textual communications that are translated by transformation engine 183 into audio communications.

The audio source 3D space localizer 120 includes a user interface (UI) generator and manager 124. The UI provides for interaction by a user with the audio source 3D space localizer. For example, the UI allows for defining source locations of audio sources within a 3D space; defining priorities of audio sources and/or communications within an audio source; setting volume levels of audio from each audio source, or audio levels of communications of each entity over a single audio source; and for providing additional modifications to audio from audio sources or communications within an audio source, such as setting frequencies, or setting filtering functions including the reduction and/or elimination of audio from an audio source, or communications within an audio source, at one or more locations within a 3D audio space.

The audio source 3D space localizer 120 includes a source location assigner 121 that is configured to define a corresponding source location for each of the plurality of audio sources 180 provided as input within a 3D audio space. Also, source location assigner 121 is able to provide for and/or recognize movement of a source location of a corresponding audio source from one location to another location within the 3D space. As previously described, the source location assigner 121 assigns source locations based on user input (e.g., via UI), predefined user preferences, predefined rules, learned rules using AI, or a combination thereof. As such, directional audio from each audio source is presented to the user within the 3D audio space, such that audio of a corresponding audio source originates from a corresponding source location in the 3D audio space. Spatial separation of audio sources, and/or communications within an audio source, within the 3D audio space is dynamically maintained to reduce conflicts between the audio broadcast from corresponding source locations.

The audio source 3D space localizer 120 includes a priority engine 122 configured for defining a hierarchy of priorities between audio sources and/or communications within an audio source, wherein the priorities may be determined through user selection, automatically through predefined rules, or through artificial intelligence, or a combination thereof. In particular, inter-audio source priority manager 122A is configured to define priorities for one or more audio sources to define a hierarchy of inter-audio source priorities. For example, audio from a social networking chat audio source focused on communications between team members participating in a multi-player gaming session of a video game may have higher priority over an audio source providing communications from followers of the user. In another example, local communications (i.e., originating in the same physical environment as the user) may have the highest priority. For instance, the user may prefer to know wat is going on locally, such as when the pizza has arrived, or when someone is calling on the phone, or when someone local needs to communicate with the user.

Also, intra-audio source priority manager 122B is configured to define priorities for communications from one or more entities grouped within a single audio source to define a hierarchy of intra-audio source priorities. For example, in an audio source of communications from friends of a user, there may be communications from multiple friends. Friend number one may be exceptionally loud. Friend number two may always provide useful information regarding the video game being played by the user. Friend number three may have a reputation for always meming or joking around when communicating. In this situation, the user may define or prefers that communications from friend number two has a higher priority over communications from friend number one. Also, friend number three may have the lowest priority.

Priority engine 122 may work cooperatively with the source location assigner 121 to provide for spatial separation of audio from the plurality of audio sources 180 and/or the audio 186 from the underlying application (e.g., video game). The spatial separation (e.g., through assignment of source locations) may be dynamically performed based on a hierarchy of inter-audio source priorities and/or a hierarchy of intra-audio source communication priorities. That is, source locations of audio sources, and/or communications within an audio source, can be automatically moved around spatially within the 3D audio space based on priorities of those audio sources and/or priorities of communications within an audio source.

Along with spatial separation, additional operations may be performed to distinguish audio from the audio sources and/or communications within an audio source. These operations may be performed based on priorities of those audio sources and/or priorities of communications within an audio source. The operations may also be performed based on rules, such as those to avoid conflict between audio of audio sources, or communications within an audio source, that may be determined through user selection, automatically through predefined rules, or through artificial intelligence, or a combination thereof. For example, the volume and frequency and location modifier 122C may perform these additional operations based on priorities or other rules. In particular, the modifier 122C may be configured for filtering audio from an audio source, and/or audio from the underlying application (e.g., video game) so that the audio from the audio source or the underlying application is more prominent. In some cases, the modifier 122C is configured for increasing or decreasing volumes of audio from one or more audio sources, and/or increasing or decreasing volumes of audio from one or more entities providing audio for a single audio source. Filtering may include performing programmed operations to modify the audio, and include, but are not limited to, increasing or decreasing volume of audio, removing audio for the underlying application that is emanating near the source location of a corresponding audio source, changing the frequency of the audio of the audio source and/or the underlying application, etc. As previously described, the modifier 122C may also be configured for moving a source location of an audio source, and/or communications within an audio source, based on priorities and/or to avoid conflict between audio of different audio sources and/or communications within an audio source.

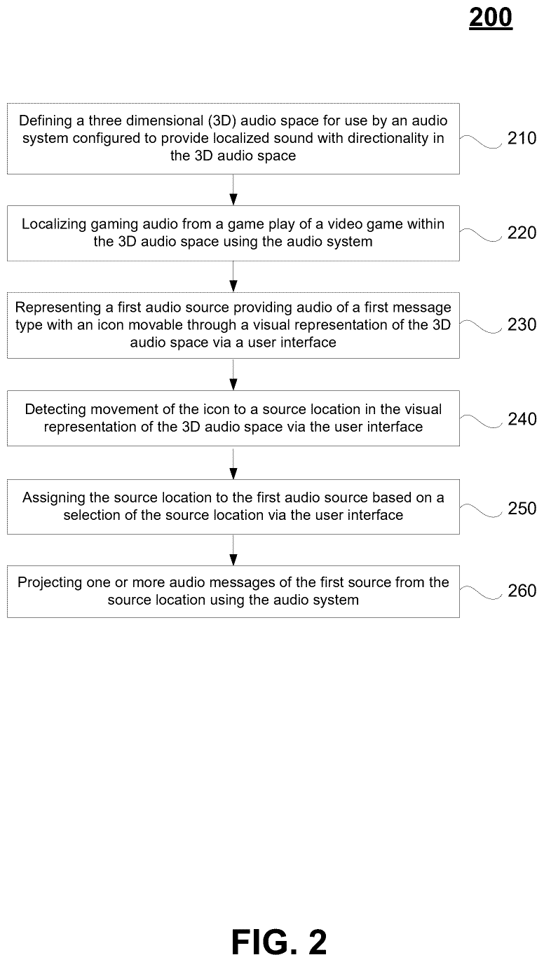

With the detailed description of the system 100 of FIG. 1A and the audio source 3D space localizer 120 of FIG. 1B, flow diagram 200 of FIG. 2 discloses a method for providing directional audio in a 3D audio space for corresponding audio sources, in accordance with one embodiment of the present disclosure. In that manner, different audio sources that are spatially separated can be distinguishable from each other, and from an underlying application, such as a video game. Also, different communications within an audio source that are spatially separated can be distinguishable from each other, and from an underlying application. The operations performed in the flow diagram may be implemented by one or more of the previously described components of system 100 described in FIGS. 1A-1B, including the audio source 3D space localizer 120.

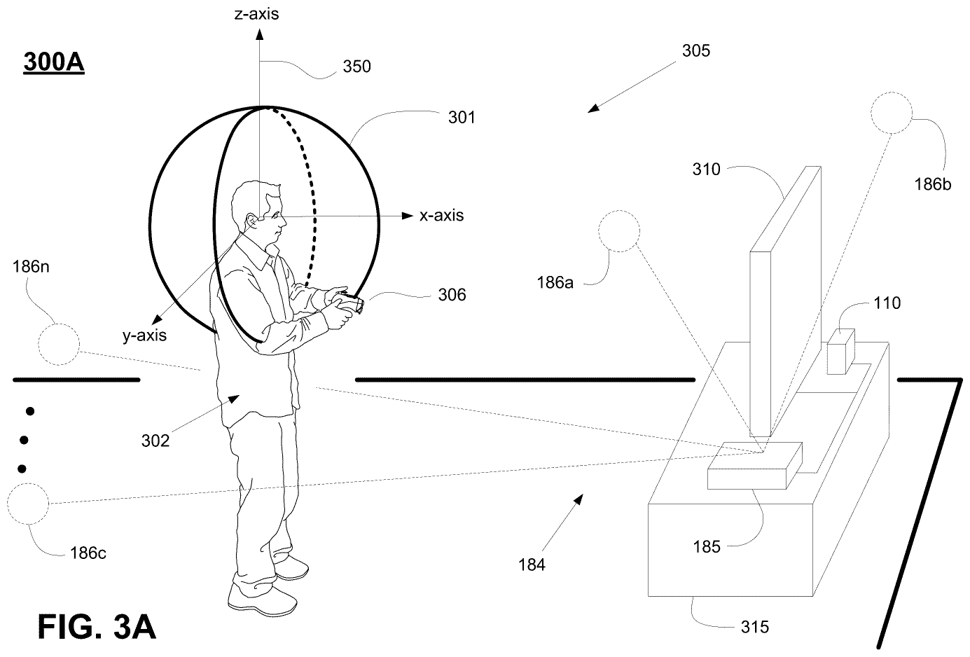

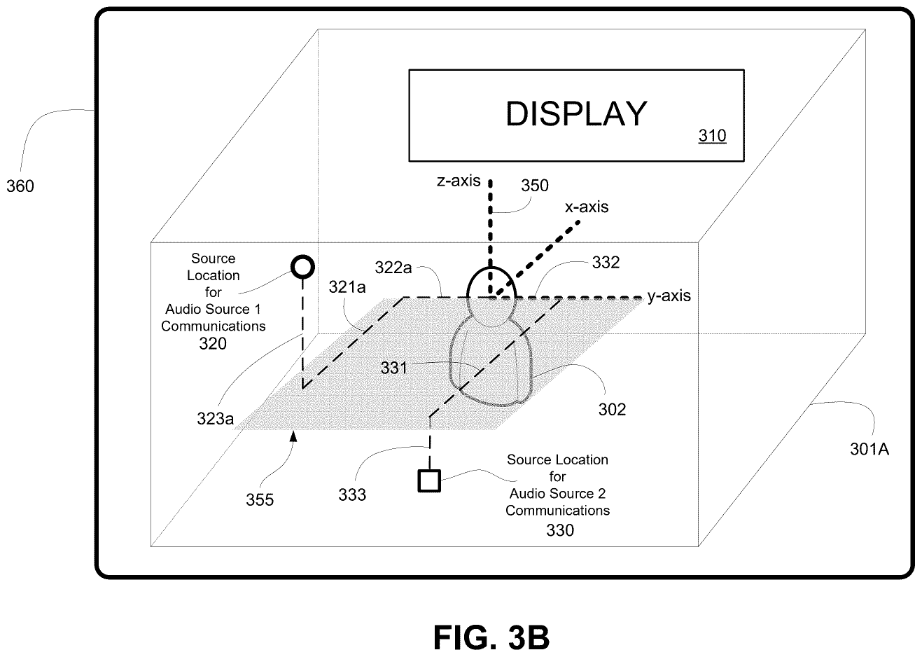

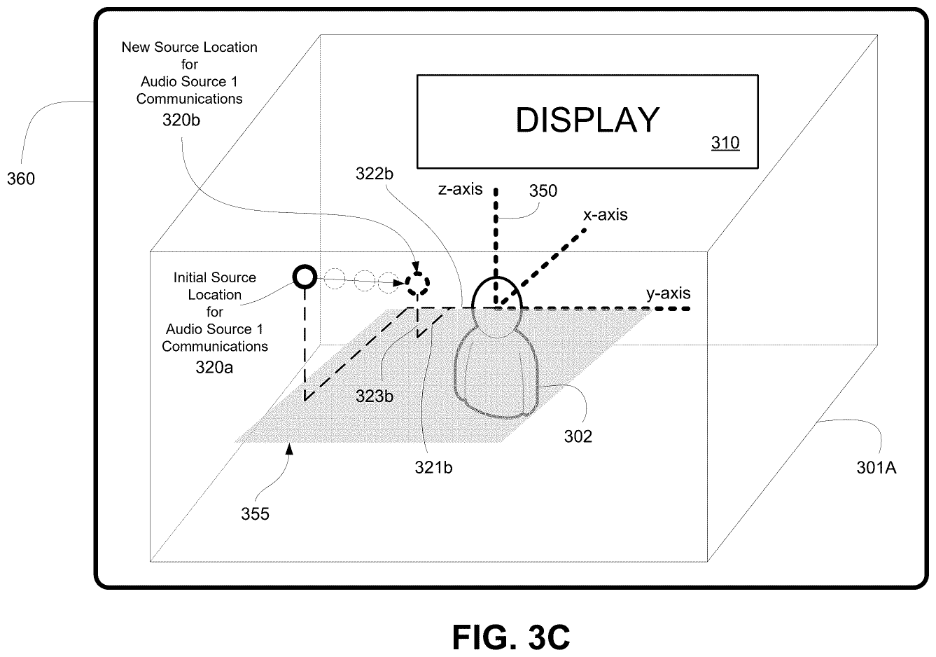

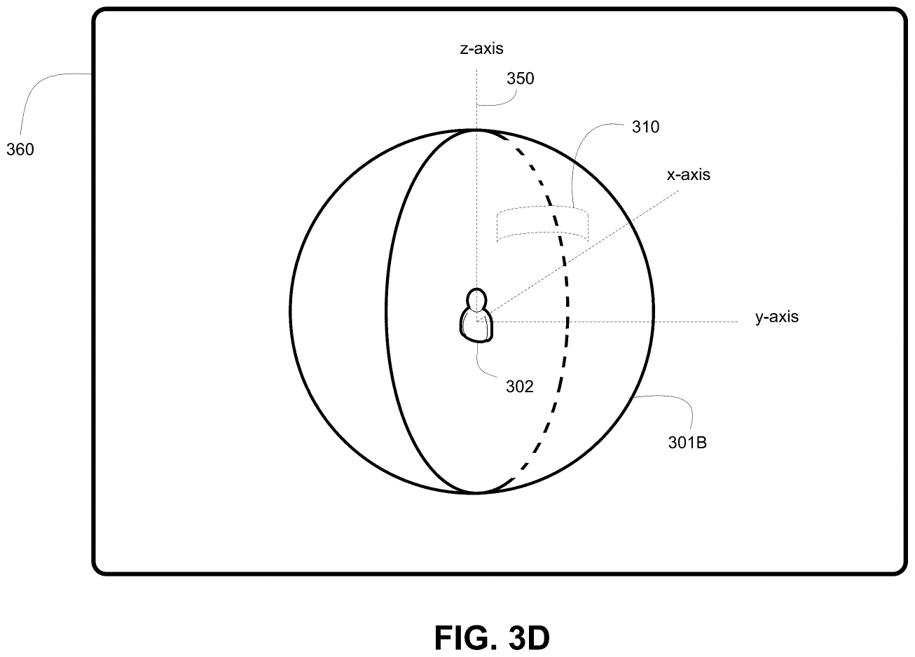

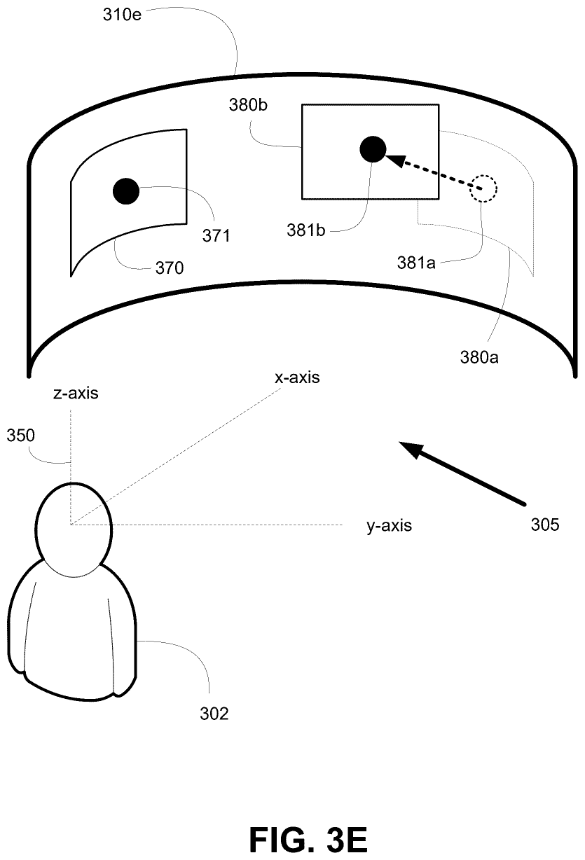

At 210, the method includes defining a 3D audio space for use by an audio system configured to provide localized sound with directionality in the 3D audio space. 3D audio, or surround sound, is configured to give directionality to audio or sounds presented to a listener or user of the system. In one implementation, the 3D audio is generated with a 3D audio system (e.g., system 185) that includes multiple speakers, and a possibly a subwoofer. In another implementation, a 3D audio space may be defined by an HMD configured to present 3D audio to a user. Generally, the 3D audio system generates or modifies audio input (e.g., audio sources, gaming audio, etc.) using different techniques (e.g., software implemented) based on a defined 3D audio space, so that corresponding audio originates from corresponding locations within the 3D audio space. An example of the 3D audio space as defined and implemented by a 3D audio system is provided in FIG. 3A.

At 220, the method includes localizing gaming audio from an underlying application, such as a game play of a video game within the 3D audio space using the 3D audio system. For example, gaming audio is generated for 3D audio capability. That is, the audio signals generated by the video game are formatted for presentation within the 3D audio space. A 3D audio system receiving the audio signals from the video game is configured to further manipulate the audio appropriately to present 3D audio within the defined 3D audio space.

At 230, the method includes representing a first audio source providing audio of a first message type with an icon movable through a visual representation of the 3D audio space via a user interface. The user interface may be presented via a display on a device of the user, and is configured to provide a representation of the 3D audio space for viewing and/or interaction. The UI allows for interaction with the representation of the 3D audio space. In particular, the UI allows the user to place and/or manipulate placement of an audio source within the representation of the 3D audio space. For instance, the first audio source may be represented by a selectable icon within the representation of the 3D audio space. Further, the icon is defined by a corresponding location as presented in the representation of the 3D audio space. In one example, the icon is a bubble. Other representations other than a bubble is well suited for source representation within the UI. As previously described, one or more audio sources include distinct audio content generated independent of the audio from the underlying application, such as a video game. In particular, audio from the audio sources are formatted with different messaging types, such as chat services, texting services, communication from friends, communication from followers, information provided related to the video game, communication from the local environment, etc., as previously introduced.

At 240, the method includes detecting movement of the icon to a source location in the visual representation of the 3D audio space via the user interface. In one implementation, the audio bubble icon can be moved in the representation of the 3D audio space to a desired location, which is the source location (e.g., initial source location) for the corresponding audio source. In that manner, audio of a corresponding audio source (e.g., the first audio source) originates from the defined source location in 3D audio space as presented using the 3D audio system. The source location also may correspond to a location in physical space, from which the corresponding audio seemingly originates. Further, the source location may be tied to a virtual reality (VR) space when using an HMD.

In another embodiment, the user interface provides for additional movement of the icon through the representation of the 3D audio space. For example, once an initial source location is defined using the representation of the 3D audio space, such as through initial movement and placement of the icon, additional movement of the icon is supported. That is, the icon is movable from the initial source location to a new source location, such as via interaction with the UI by the user with the representation of the 3D audio space. For example, movement of the icon is detected from the source location to the new, second location in the representation of the 3D audio space, such as via interaction with the user interface. The final resting location of the icon in the representation of the 3D audio space is now defined as the new or second source location for that audio source (i.e., the first audio source). In particular, the new or second location is assigned to the first audio source based on a selection of the second location via the user interface. In that manner, audio of the first audio source will now originate from the newly defined source location within the 3D audio space as presented using the 3D audio system. For example, one or more audio messages of a first message type of the first audio source are projected from the second location using the 3D audio system.

At 250, the method includes assigning the source location to the first audio source based on a selection of the source location via the user interface. As such, a currently defined source location of the first audio source defines where audio of the audio source will originate within the 3D audio space. For example, the currently defined source location may be the initial source location of the first audio source, or the new source location, such as when defined by movement of the icon from the initial source location to the new source location.

At 260, the method includes projecting one or more audio messages of the first audio source from the source location (i.e., the currently defined source location) using the audio system. In particular, the 3D audio system is configured to manipulate audio input such that audio from the first audio source originates and/or seemingly originates from the currently defined source location (e.g., initial source location, new source location, etc.) within the 3D audio space. As such, each of the audio messages in the first audio source originates from the currently defined source location, as broadcast using the 3D audio system.

The method is configured to handle a plurality of audio sources of a plurality of message types. In particular, the plurality of audio sources is represented with a plurality of icons in the representation of the 3D audio space. That is, each of the plurality of audio sources is represented with a corresponding icon. Further, each of the plurality of icons is movable through the representation of the 3D audio space, such as via user interaction with the user interface to select the plurality of source locations. Movement of the plurality of icons to a plurality of source locations is detected in the representation of the 3D audio space, such as via data collected from interactions with the user interface. As such, each of the plurality of icons is moved to a corresponding source location in the representation of the 3D audio space. Further, the plurality of source locations is assigned to the plurality of audio sources based on a plurality of selections of the plurality of source locations, such as via interactions with the user interface. One or more audio messages for each of the plurality of audio sources is projected from a corresponding source location. For example, the 3D audio system is configured to manipulate audio input from each of the plurality of audio sources, such that audio from the corresponding audio source originates and/or seemingly originates from a corresponding source location within the 3D audio space.

FIG. 3A illustrates a perspective view of a physical environment 305, such as home environment. For example, a user 302 is shown controlling game play of a video game using a gaming controller 306. In particular, a 3D audio space 301 is defined within which one or more audio sources may be assigned to source locations within the audio space, such that directional audio for those audio sources is provided in addition to audio from a video game, in accordance with one embodiment of the present disclosure. In some implementations, the 3D audio space may be defined within the physical environment 305. In other implementations, the 3D audio space is defined around the user 302. In still other implementations, the 3D audio space is defined with respect to a HMD. As shown, the video game may be executing and/or streaming through client device 110, such as a gaming console, located on table 315 in association with the game play of the user 302, wherein the game play is responsive to user input, such as through gaming controller 306. A primary stream of the game play is created, wherein video of the game play is delivered to display 310.

3D audio, or surround sound, is configured to give directionality to audio or sounds presented to a listener or user of the system. In one implementation, the 3D audio is generated with a 3D audio system 184, including a controller 185 (e.g., receiver) and one or more speakers 186 (e.g., soundbar, speakers, subwoofer, etc.). For example, the 3D audio system 184 includes speakers 186a, 186b, 186c, . . . and 186n that are located in various locations throughout the physical space 301 (e.g., room). In another implementation, a 3D audio space may be defined by an HMD configured to present 3D audio to a user. Generally, the 3D audio system 304 generates or modifies audio input (e.g., audio sources, gaming audio, etc.) based on a defined 3D audio space, so that corresponding audio (e.g., from audio sources or gaming system, etc.) originates from corresponding locations within the 3D audio space 301.

In particular, the 3D audio system 184 generates or modifies audio input (e.g., audio sources, gaming audio, etc.) based on the defined 3D audio space 301. The 3D audio space may be defined based on knowledge of the physical space 305 through which the audio is presented. For example, various models may be utilized representing the 3D audio space, such as a box model, or spherical model. For purposes of illustration, the 3D audio space 301 is shown in FIG. 3A as a spherical space, which may be expandable, though it can also be represented by a rectangular box (e.g., corresponding to the room), or any other shape. The center of the 3D audio space anchors the 3D coordinate system 350, including an x-axis, a y-axis, and a z-axis. As shown, the x-axis extends out in a positive direction from the front of the user. The 3D coordinate system 350 may be used to provide positioning information of audio originating within the 3D audio space 301.

One or more speakers 186 in the 3D audio system 184 are spread out through the physical space 305 to give a sense of directionality of broadcasted audio within the 3D audio space 301. Some example configurations of speakers 186 are provided by a 5.1 3D audio system (including 5 speakers and 1 subwoofer) and a 7.1 3D audio system (including 7 speakers and 1 subwoofer). Directionality is achieved through distribution of sound components to selected speakers and software manipulation of the sound components depending on the number of speakers and configuration of those speakers within the physical space. In addition, a 3D audio space may be defined by an HMD configured to present 3D audio to a user.

Furthermore, different techniques may be implemented to provide directionality.

For example, audio components may be mixed at a content level for a particular set of audio sources in a particular configuration through a physical space. In another example, audio sources are located within a spherical 3D space (such as that shown in FIG. 3A), and audio components are generated according to those locations via software manipulation. Other techniques are also utilized for generating 3D audio. In that manner, an audio component appears to the user to originate from a specific location within the 3D audio space FIG. 3B illustrates a user interface 360 implemented to assign source locations to one or more audio sources in a rectangular boxed representation of a 3D audio space, in accordance with one embodiment of the present disclosure. User interface 360 provides for user interaction, and may be presented on a display (e.g., display 310, or HMD, etc.) viewable by the user 302.

A visual representation 301A of the 3D audio space 301 is shown in UI 360. The visual representation 301A is shown as a rectangular box in the UI 360, such that the 3D audio space 301 is represented by the rectangular box. The visual representation 301A is a virtual representation of the 3D audio space 301 as shown in the UI 360. User 302 is also shown in FIG. 3B, for purposes of illustration, to show assumed positioning of the user within the 3D audio space 301, so that the user is able to experience 3D audio in full. Typically, the user is not shown in the UI 360.

As shown, the center of the 3D audio space 301 is anchored by the 3D coordinate system 350, including an x-axis, a y-axis, and a z-axis. As shown, the x-axis extends out in a positive direction from the front of the user. The 3D coordinate system 350 may be used to provide positioning information of audio originating within the visual/virtual representation 301A of the 3D audio space 301. For clarity in positioning within the 3D coordinate system 350 a portion of a horizontal plane 355, defined by the x-axis and the y-axis, is shown in gray, and with transparency. For example, the user 302 is mostly below horizontal plane 355, wherein the head of the user is centered about the origin of the 3D coordinate system 350.

As previously described, a plurality of audio sources of a plurality of message types may be manually positioned throughout the visual/virtual representation 301A of the 3D audio space 301, such as via the UI 360. In particular, the plurality of audio sources is represented with a plurality of icons in the UI 360. That is, each of the plurality of audio sources is represented with a corresponding icon. For example, a circular icon represents audio source 1 (one), and a box icon represents audio source 2 (two).

Further, each of the plurality of icons is movable through the visual/virtual representation 301 of the 3D audio space, such as via user interaction with the user interface to select the plurality of source locations. Movement and/or placement of the icons is detected in the visual/virtual representation 301A in the UI 360 to determine source locations of each of the audio sources. For example, a source location 320 for audio source 1 (i.e., circle icon) is shown above the horizontal plane 355, and behind the user positioned at the center of the visual/virtual representation 301A of the 3D audio space 301. For instance, source location 320 may be further defined by an x-component 321a, a y-component 322a, and a z component 323a. As such, source location 320 for audio source 1 is located above and behind the user 302. That is, communications from audio source 1 is projected to originate from source location 320 by the corresponding 3D audio system.

Also, a source location 330 for audio source 2 (i.e., box icon) is shown below the horizontal plane 355, and also behind the user positioned at the center of the visual/virtual representation 301A of the 3D audio space 301. For instance, source location 330 may be further defined by an x-component 331, a y-component 332, and a z component 333. As such, source location 330 for audio source 2 is located below and behind the user 302. That is, communications from audio source 2 is projected to originate from source location 330 by the corresponding 3D audio system.

FIG. 3C illustrates the user interface 360, introduced in FIG. 3B, implemented to recognize placement and/or movement of a source location of an audio source within a visual/virtual representation 301A of a 3D audio space 301, in accordance with one embodiment of the present disclosure. Similarly numbered features appearing in each of FIGS. 3B and 3C are configured similarly, and the description for those features previously described in FIG. 3B are equally applicable to FIG. 3C.

Movement and/or placement of the icons is detected in the visual/virtual representation 301A in the UI 360 to determine source locations of a corresponding audio source. FIG. 3C illustrates the movement of audio source 1 (one) represented by the circular icon. An initial source location 320a for audio source 1 is shown above the horizontal plane 355, and behind the user positioned at the center of the visual/virtual representation 301A of the 3D audio space 301. The initial source location 320 may correspond with the source location 320 first placed into the visual/virtual representation 301A of the 3D audio space 301 in FIG. 3B.

The user may interact with the icon for audio source 1 via the UI 360 to indicate described movement of the source location. For example, the circular icon representing audio source 1 is shown to be moved from the initial source location 320a to a second or new source location 320b. In particular, the new source location 320b may be further defined by an x-component 321b, a y-component 322b, and a z component 323b. That is, the new source location 320b for audio source 1 is moved closer to the left ear of the user, wherein the source location 320b for audio source 1 is located above and behind the user 302. As such, communications from audio source 1 is projected to originate from new or second source location 320b by the corresponding 3D audio system.

FIG. 3D illustrates the user interface 360 implemented for placement and/or movement of source locations of one or more audio sources within a visual/virtual representation 301B of the 3D audio space 301, in accordance with one embodiment of the present disclosure. The visual/virtual representation 301B is shown as a sphere in the UI 360, such that the 3D audio space 301 is represented by the sphere for purposes of user interaction. Other shapes and/or representations of the 3D audio space 301 are also supported. A user 302 is shown, for purposes of illustration, in an assumed position within the 3D audio space 301, so that the user is able to experience 3D audio in full. Typically, the user is not shown in the UI 360. Further, the center of the 3D audio space 301 is anchored by the 3D coordinate system 350, including an x-axis, a y-axis, and a z-axis. As shown, the x-axis extends out in a positive direction from the front of the user, and towards a representation of a location of display 310 (i.e., the display is typically in front of the user). The 3D coordinate system 350 may be used to provide positioning information of audio originating within the visual/virtual representation 301B of the 3D audio space 301.

FIG. 3E illustrates localized audio from corresponding window or display locations within a 3D audio space 301 (not shown), so that directional audio from a corresponding window or display is aligned with a physical location of the window or display, in accordance with one embodiment of the present disclosure. A perspective view of a physical environment 305 is shown, such as home environment. In particular, the center of the 3D audio space 301 (not shown) is anchored by the 3D coordinate system 350, including an x-axis, a y-axis, and a z-axis. As shown, the x-axis extends out in a positive direction from the front of the user 302. The 3D audio space 301 is defined within which one or more audio sources may be assigned to source locations within the audio space, such that directional audio for those audio sources is provided in addition to audio from an underlying application, such as a video game.

For example, the user 302 may be viewing one or more applications on a wide screen display 310e. As shown, window 370 presents video images for a first application (e.g., a communication audio source, etc.), wherein window 370 is located on the left side of the wide screen display 310e. Audio generated for the first application may appear to be broadcast from source location 371, which may correspond with a point associated with (e.g., the center) of window 370 presented on display 310e. That is, source location 371 defines a point in the 3D audio space, and may also correspond with a point in the physical space 305 that is associated with the window 370.

Furthermore, the source location may be tied to the presentation of the application within a corresponding window. For example, a window on display 310e presents video images for a second application (e.g., a communication audio source, etc.), wherein the window generally is located on the right side of the wide screen display 310e. Audio generated for the second application may be tied to a location and/or positioning (including movement) of the window on display 310e. For example, window 380a shows an initial position on display 310e, wherein audio generated for the second application may initially appear to be broadcast from source location 381a, which may correspond with a point associated with (e.g., the center) window 380a. The user may move the window to a second location, such that window 380b shows a second or new position on display 310e. After movement of the window, because the audio is tied to the placement of the window 380b on display 310e, and/or positioning of the window 380bb in the 3D audio space, audio generated for the second application may now appear to be broadcast from the second source location 381b, which may correspond with a point associated with (e.g., the center) of window 380b.

In another implementation, the user 302 may be using multiple displays instead of single display to present multiple applications. For example, each application is presented on a corresponding display. Audio of an application (e.g., audio source, etc.) may be assigned to a source location within 3D audio space that is tied to a window on a display and/or a corresponding display. As such, audio generated for a corresponding application presented on a display may appear to be broadcast from a corresponding source location in 3D audio space that is associated with positioning of the display in physical space. As such, audio from that application appears to be coming from the display.

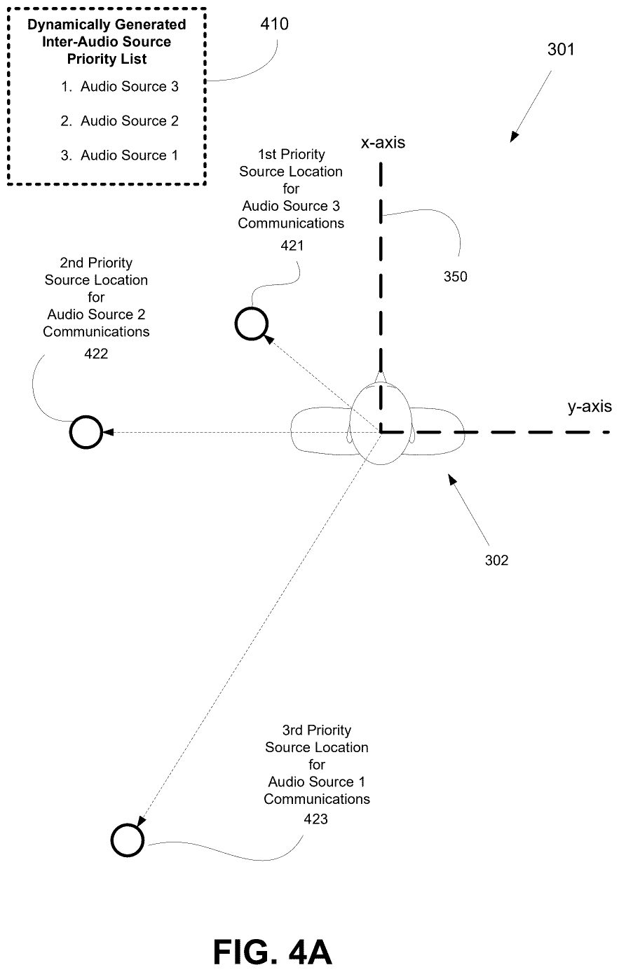

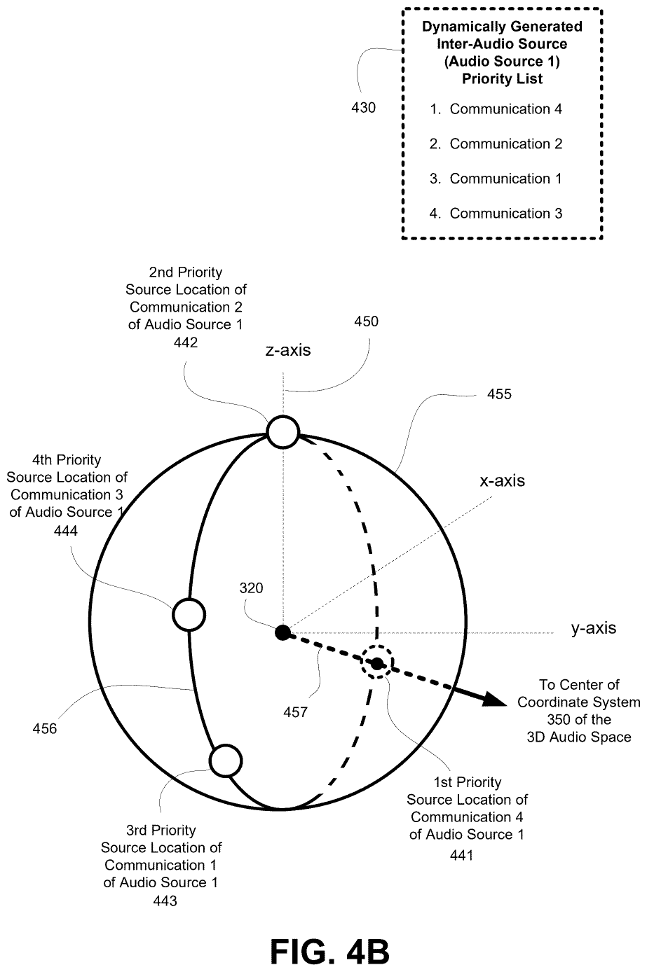

FIGS. 4A-4B illustrate the use of priorities for automatic placement of audio sources and/or communications within an audio source within a 3D audio space. As previously described, priorities may be determined through user selection, automatically through predefined rules, or through artificial intelligence, or a combination thereof.

In particular, FIG. 4A illustrates the assignment of source locations of audio sources within a 3D audio space based on inter-audio source priorities, in accordance with one embodiment of the present disclosure. For example, priority assignment and performance of operations based on the priorities may be performed by inter-audio source priority manager 122A. In particular, the center of the 3D audio space 301 is anchored by the 3D coordinate system 350, which includes an x-axis and a y-axis. The x-axis is shown to extend in the positive direction away from the front of the user 302. For purposes of clarity and simplicity, the z-axis is not shown, and automatic placement of source locations of corresponding audio sources is shown on a horizontal plane defined by the x-axis and the y-axis. It is understood that automatic placement of source locations of corresponding audio sources may occur within a 3D audio space represented by an x-axis, a y-axis, and a z-axis. The 3D coordinate system 350 may be used to provide and illustrate positioning information of audio originating within the 3D audio space 301.

In particular, a hierarchy of priorities is defined for a plurality of audio sources, wherein the audio sources are configured to provide a plurality of message types. For example, list 410 shows the hierarchy of priorities for the audio sources, wherein audio source 3 (three) has the highest priority, audio source 2 (two) has the second highest priority, and audio source 1 (one) has the lowest priority. The hierarchy may be influenced by user preference, pre-defined rules, AI rules, AI learned rules of user preferences, etc.

In addition, a plurality of source locations in the 3D audio space 301 is dynamically and automatically assigned to the plurality of audio sources based on the hierarchy of priority. The assignment may override or be based on a manual positioning of a corresponding audio source. In one implementation, higher priority audio sources are positioned within the 3D audio space to present the audio from the most optimum point in relation to other audio sources. For example, because audio source 3 has the highest priority, the corresponding source location 421 is positioned closest to the center of the 3D audio space 301 corresponding to the origin of the 3D coordinate system. It is assumed that the user 302 is positioned near the center of the 3D audio space 301. Because audio source 1 has the lowest priority, the corresponding source location 423 is positioned furthest from the center of the 3D audio space 301. As such, audio from audio source 1 is broadcast at a lower level than audio from audio source 3, wherein corresponding volume of the audio of a corresponding audio source presented to the user is reflective of the distance from the center of the 3D audio space. Also, because audio source 2 has a middle priority, the corresponding source location 422 is located further away from the user 302 (as represented by the center of the 3D audio space 301) than the source location for audio source 1 (because audio source 2 has a lower priority than audio source 1), but is located closer to the user 302 than the source location for audio source 3 (because audio source 2 has a higher priority than audio source 3.

In one embodiment, the hierarchy may be dynamically defined according to current conditions. As an illustration, the hierarchy may be influenced by user preference, pre-defined rules, AI rules, AI learned rules of user preferences, etc. As such, audio source parameters may be detected, which induces a change in the hierarchy of priority between audio sources.

As such, a change in the hierarchy may also be detected. For example, the hierarchy may be changed when a component (e.g., audio source or communication within an audio source) enters or leaves. Based on the new hierarchy of priority between audio sources or the detection of a change in the hierarchy, the plurality of source locations in the 3D audio space for the plurality of audio sources is adjusted.

In another embodiment, source location and/or volume manipulation of audio sources may be performed based on a hierarchy of priorities between the audio sources. In particular, a hierarchy of priorities is defined for a plurality of audio sources. As previously described, a plurality of source locations in the 3D audio space is assigned to the plurality of audio sources. Furthermore, a plurality of volume levels is assigned to the plurality of audio sources based on the hierarchy of priority. As previously described, a corresponding volume of audio of a corresponding audio source may be reflective of the distance of the corresponding source location from the center of the 3D audio space, wherein audio of an audio source, from a further source location to the user, has a lower volume than audio of an audio source, with a source location closer to the user. Additional volume control may be performed based on the hierarchy of priorities. For example, the audio source with the highest priority may receive a boost in volume, whereas an audio source with the lowest priority may receive a further lowering in a corresponding volume. As such, one or more audio messages for each of the plurality of audio sources is projected from a corresponding source location and at a corresponding volume level (i.e., modified volume level).

FIG. 4B illustrates the assignment of source locations of communications within an audio source from different entities within a 3D audio space based on intra-audio source priorities, in accordance with one embodiment of the present disclosure. For example, priority assignment and performance of operations based on the priorities may be handled by the intra-audio source priority manager 122B. In particular, source and volume control may be performed on communications within an audio source. For purposes of illustration, audio source 1 (one) previously introduced in FIG. 3B is used to show location and/or volume control to distinguish communications from different entities within audio source 1. As such, source location 320 located within a 3D audio space (not shown) is assigned to audio source 1.

A plurality of communicators generating the one or more audio messages of a first audio source (e.g., audio source 1 including messages of a first message type) is determined. A plurality of sub-source locations is assigned to the plurality of communicators. The assignment of source locations may be influenced by user preference, pre-defined rules, AI rules, AI learned rules of user preferences, etc. Further, each of the plurality of sub-source locations is offset from the source location 320 to give directionality to the one or more audio messages from the plurality of communicators. A 3D coordinate system 450 is anchored to the source location 320 of audio source 1 within the 3D audio space. The 3D coordinate system 450 includes an x-axis, a y-axis, and a z-axis. An arrow 457 from the source location 320 is pointed in the direction of the center of the 3D coordinate system 350 corresponding with the center of the 3D audio space 301. Also, one or more audio messages from each of the plurality of communicators are projected from a corresponding sub-source location. As such, messages from different communicators can be distinguishable by the user because of the directionality of those messages.

In one embodiment, a hierarchy of priorities is defined for the communicators within an audio source. For example, list 430 shows the hierarchy of priorities for the communicators and/or entities, wherein communication 4 (four) has the highest priority, communication 2 (two) has the next highest priority, communication 1 (one) has the next highest priority, and communication 3 (three) has the lowest priority. Each of the communications may originate from a different entity, such as different participants in a chat, when audio source 1 supports a chat discussing the video game. The hierarchy may be influenced by user preference, pre-defined rules, AI rules, AI learned rules of user preferences, etc.

In addition, a plurality of source locations in the 3D audio space is dynamically and automatically assigned to the plurality of communicators within audio source 1 based on the hierarchy of priority. For example, communicators with higher priority are positioned within the 3D audio space in better sub-source locations for audio projection in relation to source locations of other communicators having lower priorities. The sub-source locations are configured to provide directionality to audio from each of the communicators that is distinguishable to the user. For example, sub-source locations may be configured as an arc around the source location 320 of the audio source 1.

For purposes of illustration, sub-source locations may be spread around a surface of a virtual sphere 455 that is centered about source location 320 of audio source 1 within the 3D audio space. Only for purposes of illustration, the sub-source locations may be located on a circle defining a corresponding circumference 456 on sphere 455. The plane of the circle 456 may include the arrow 457. As shown, because communication 4 has the highest priority, the corresponding sub-source location 441 is positioned closest to the center of the 3D audio space 301, which corresponds to the origin of the 3D coordinate system 350 (not shown). That is, sub-source location 441 appears on the hidden side of the circle 456 of sphere 455 in FIG. 4B. Additional sub-source locations of corresponding communicators may appear on circle 456 at locations that are further from the center of the 3D audio space 301 than sub-source location 441. For example, because communication 3 of audio source 1 has the lowest priority, the corresponding sub-source location 444 on circle 456 is positioned furthest from the center of the 3D audio space 301. Communication 2 of audio source 1 with the second highest priority is located at the sub-source location 442 on circle 456, and is positioned further than sub-source location 441, but closer than sub-source 444. Also, communication 3 of audio source 1 with the third highest priority is located at sub-source location 443 on circle 456, and is positioned further than sub-source location 442, but closer than sub-source 444.

In still another embodiment, sub-source location, and/or volume manipulation of communications of an audio source, may be performed based on a hierarchy of priorities between the communications. In particular, a hierarchy of priorities is defined for a plurality of communications and/or communicators of those communications. Each of the communicators present one or messages of the message type for the corresponding audio source (e.g., audio source 1). As previously described, in a chat of audio source 1, one communicator may always present important information, while another communicator is always joking around. If the user values information over joviality, then the communicator presenting useful information may have a higher priority than the other user. A plurality of sub-source locations is assigned to the communications and/or communicators based on the hierarchy of priorities. Furthermore, a plurality of volume levels is assigned to the plurality of communications and/or communicators based on the hierarchy of priority. That is, in addition to volume levels influenced by the distance from the center of the 3D audio space for each sub-source location of corresponding communications and/or communicators, additional volume control may be performed based on the hierarchy of priorities. For example, the communication with the highest priority may receive a boost in volume, whereas a communication with the lowest priority may receive a further lowering in a corresponding volume (e.g., a communication of a communicator is known to be extra loud, and is assigned a lowest priority with additional volume control lowering the volume of corresponding audio). As such, one or more communications for each of the communicators of an audio source is projected from a corresponding sub-source location and at a corresponding volume level (i.e., modified volume level).

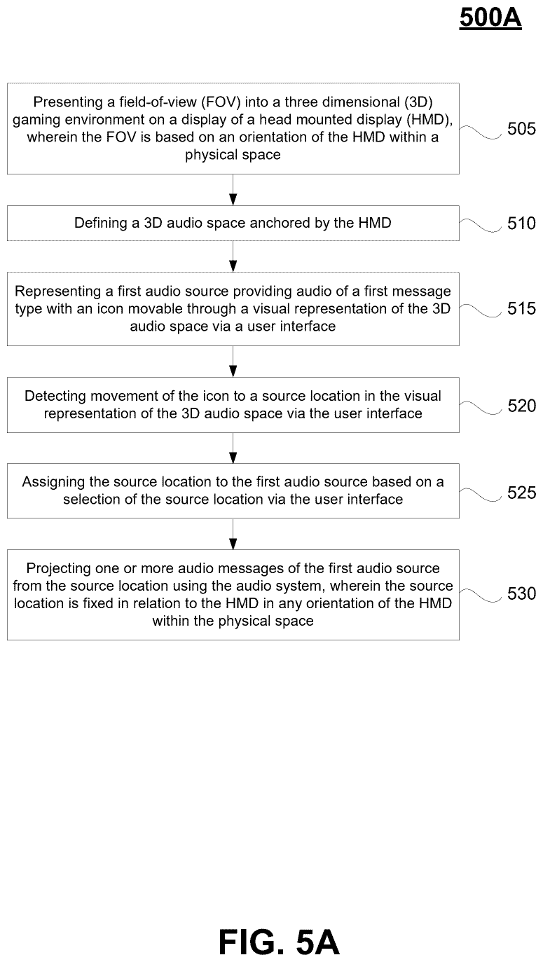

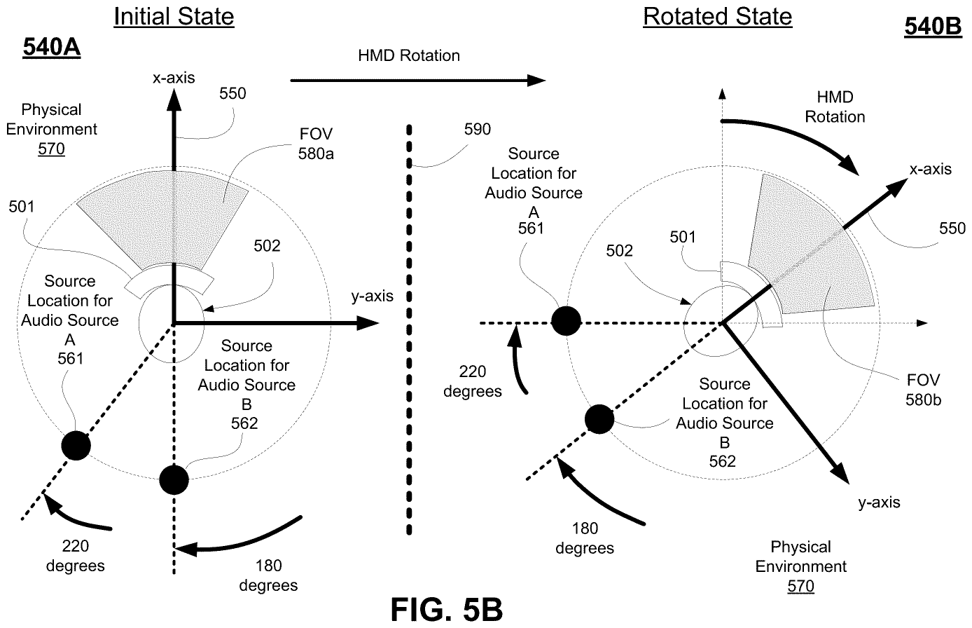

FIGS. 5A and 5B illustrate directional audio of audio sources that are projected in a 3D audio space anchored to an HMD. In particular, FIG. 5A illustrates a method and FIG. 5B illustrate an implementation of the method.

With the detailed description of the system 100 of FIG. 1A and the audio source 3D space localizer 120 of FIG. 1B, flow diagram 500A of FIG. 5A illustrates a method providing directional audio for corresponding audio sources in a 3D audio space that is anchored to a head mounted display (HMD), in accordance with one embodiment of the present disclosure. In that manner, different audio sources that are spatially separated can be distinguishable from each other, and from an underlying application, such as a video game, even when the HMD is rotated within a physical space.

At 505, the method includes presenting a field-of-view (FOV) into a three dimensional (3D) gaming environment on a display of a head mounted display (HMD. The FOV is based on an orientation of the HMD within a physical space. The video game is executed to generate the 3D gaming environment for a game play of the video game viewable by the HMD. Gaming audio is localized and/or projected from various corresponding locations within the 3D virtual gaming environment. One or more audio sources may also be presented by the HMD in combination with gaming audio of the video game.

At 510, the method includes defining a 3D audio space anchored by the HMD. The 3D audio space is generated by the HMD. Furthermore, the orientation of the 3D audio space remains fixed in relation to the HMD, regardless of the orientation of the HMD within a corresponding physical space. That is, movement of the HMD does not affect the 3D audio space. Further, the 3D audio space is isolated from the 3D virtual gaming environment.

At 515, the method includes representing a first audio source providing audio of a first message type with an icon movable through a visual representation of the 3D audio space via a user interface. The user interface may be presented via a display on a device of the user, and is configured to provide a representation of the 3D audio space for viewing and/or interaction. In particular, the UI allows the user to place and/or manipulate placement of an audio source within the representation of the 3D audio space. For instance, the first audio source may be represented by a selectable icon within the representation of the 3D audio space. The icon is defined by a corresponding location as presented in the representation of the 3D audio space.

At 520, the method includes detecting movement of the icon to a source location in the visual representation of the 3D audio space via the user interface. In that manner, audio of a corresponding audio source (e.g., the first audio source) originates from the defined source location in 3D audio space referenced to the HMD.

At 525, the method includes assigning the source location to the first audio source based on a selection of the source location via the user interface. As such, the source location defines where audio of the audio source will originate within the 3D audio space referenced to the HMD. At 530, the method includes projecting one or more audio messages of the first audio source from the source location in the 3D audio space. As previously described, the source location is fixed in relation to the HMD in any orientation of the HMD within the physical space because the 3D audio space rotates with the corresponding rotation of the HMD in the physical space.

In another embodiment, another method provides directional audio for corresponding audio sources in a 3D audio space that is anchored to a head mounted display (HMD). A 3D virtual reality (VR) space is generated and/or defined for an executing video game (e.g., for a game play). The 3D virtual space corresponds with a 3D audio space. A plurality of images is projected from the game play of the video game via an HMD. Furthermore, a source location of a first audio source is fixed relative to the head mounted display, such that the source location relative to the head mounted display remains statis for any orientation of the head mounted display in a physical space. As such, rotating the HMD to a new orientation within the physical space includes translating the source location relative to the head mounted display to a new location in the 3D audio space based on the new orientation of the HMD. One or more audio messages of the first audio source are projected from the new location in the 3D audio space. Furthermore, the described operations may be implemented with the operations of flow diagram 200 of FIG. 2.

FIG. 5B illustrates a source location of an audio source that is fixed in relation to any orientation of the HMD within a physical space, in accordance with one embodiment of the present disclosure. An initial state of the HMD 501 worn by a user 502 is shown to the left of line 590. The initial state illustrates an initial orientation of the HMD 501 within the physical environment 570. HMD 501 is configured to provide user interaction with a virtual space/environment that is responsive in real-time to the movements of the HMD (as controlled by the user) to provide the sensation to the user of being in the virtual space or metaverse. Based on the initial orientation, an FOV 580a into a virtual 3D environment is presented by the HMD 501.

In addition, coordinate system 550 defines a 3D audio space anchored by the HMD 501. For purposes of clarity and simplicity of illustration, FIG. 5B shows the coordinate system 550 in two dimensions (e.g., x-axis and y-axis), though it is understood that the 3D audio space may be represented by a 3D coordinate system. The 3D audio space is generated by the HMD. Furthermore, the orientation of the 3D audio space remains fixed in relation to the HMD, regardless of the orientation of the HMD within a corresponding physical space.

A source location 561 for audio source A is shown in the 3D audio space. In particular, the source location 561 is shown at a location that is 220 degrees clockwise from the x-axis of the coordinate system 550. As previously described, the source location defines where audio of the audio source will originate within the 3D audio space that is referenced to the HMD 501. Also, the source location 562 for audio source B is shown in the 3D audio space at a location that is 180 degrees clockwise from the x-axis of the coordinate system.

To the right of line 590, a rotated state of the HMD 501 is shown. That is, the HMD has been rotated clockwise by approximately 45 degrees within the physical environment 570. Based on the rotated orientation, an FOV 580b into a virtual 3D environment is presented by the HMD 501.

Because the defined 3D audio space is anchored to and fixed in relation to the HMD, the coordinate system 550 also rotates with the rotation of the HMD 501. As such, the source location 561 for audio source A and the source location 562 for audio source B remains fixed in the 3D audio space even with the rotation of the HMD 501. That is, the source location 561 is still 220 degrees clockwise from the x-axis of the coordinate system 550. Also, the source location 562 for audio source B is 180 degrees clockwise from the x-axis of the coordinate system 550.

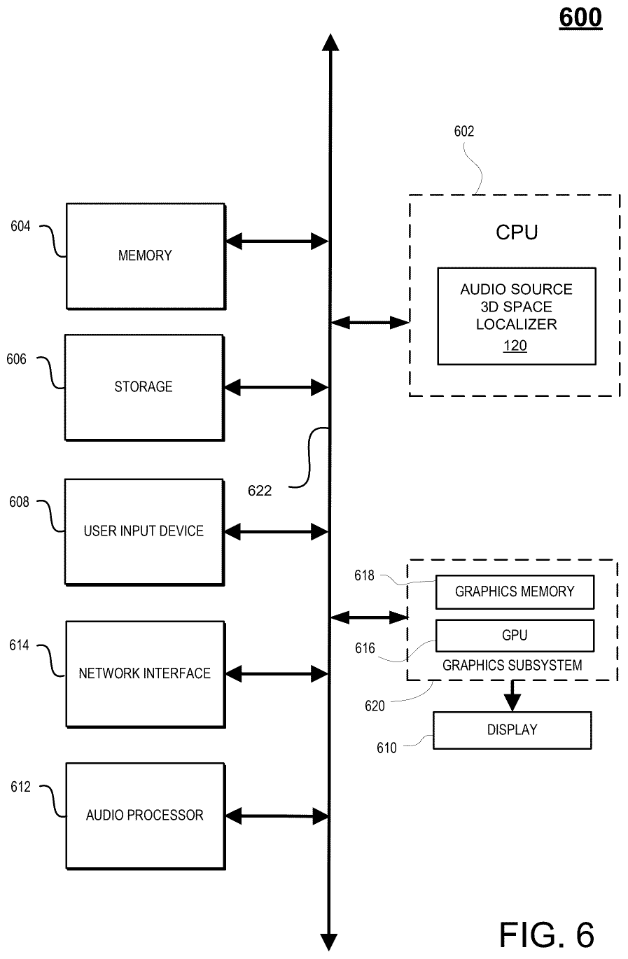

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, and includes a central processing unit (CPU) 602 for running software applications and optionally an operating system. CPU 602 may be comprised of one or more homogeneous or heterogeneous processing cores. Further embodiments can be implemented using one or more CPUs with microprocessor architectures specifically adapted for highly parallel and computationally intensive applications.

In particular, CPU 602 may be configured to implement an audio source 3D space localizer 120 that is configured to provide directional audio in a three dimensional audio space for corresponding audio sources, and/or communications within an audio source, in combination with 3D audio presented from an underlying application, such as a game play of a video game. In that manner, the audio from the audio sources, and/or communications within an audio source, are spatially separated from each other and/or the audio from the application. Each of the audio sources correspond with different message types, such as chat services, texting services, communication from friends, communication from followers, information provided related to the video game, communication from the local environment, etc. The audio source 3D space localizer 120 can be configured to respond to actions by a user, or to perform actions automatically based on rules, or perform actions automatically using AI, or a combination therein. In that manner, directional audio from each audio source, or from each of the communications within an audio source, is presented to the user within the 3D audio space, such that audio of a corresponding audio source, and/or communication within an audio source, originates from a corresponding source location in the 3D audio space.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs. In one embodiment, GPU 616 may be implemented within an AI engine (e.g., machine learning engine 195) to provide additional processing power, such as for the AI, machine learning functionality, or deep learning functionality, etc.

The graphics subsystem 620 periodically outputs pixel data for an image from graphics memory 618 to be displayed on display device 610. Display device 610 can be any device capable of displaying visual information in response to a signal from the device 600.

In other embodiments, the graphics subsystem 620 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for providing directional audio in a three dimensional audio space for corresponding audio sources, and/or communications within an audio source. In that manner, different audio sources, and/or communications within an audio source, that are spatially separated can be distinguishable from each other, and from an underlying application, such as a video game.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objects over the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to n HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
defining a three dimensional (3D) audio space for use by an audio system configured to provide localized sound with directionality in the 3D audio space;
localizing gaming audio from a game play of a video game within the 3D audio space using the audio system;
representing a first audio source providing audio of a first message type with an icon movable through a visual representation of the 3D audio space via a user interface;
detecting movement of the icon to a source location in the visual representation of the 3D audio space via the user interface;
assigning the source location to the first audio source based on a selection of the source location via the user interface; and
projecting one or more audio messages of the first audio source from the source location using the audio system.

2. The method of claim 1,
wherein the icon is a bubble.

3. The method of claim 1, further comprising:
detecting movement of the icon from the source location to a second location in the representation of the 3D audio space via the user interface;
assigning the second location to the first audio source based on a selection of the second location via the user interface; and
projecting the one or more audio messages of the first message type from the second location using the audio system.

4. The method of claim 1, further comprising:
representing a plurality of audio sources of a plurality of message types with a plurality of icons movable through the representation of the 3D audio space via the user interface;
detecting movement of the plurality of icons to a plurality of source locations in the representation of the 3D audio space via the user interface;
assigning the plurality of source locations to the plurality of audio sources based on a plurality of selections of the plurality of source locations via the user interface; and
projecting one or more audio messages for each of the plurality of audio sources from a corresponding source location.

5. The method of claim 1, further comprising:
assigning a hierarchy of priority to a plurality of audio sources of a plurality of message types;
assigning a plurality of source locations in the 3D audio space to the plurality of audio sources based on the hierarchy of priority;
detecting a change in the hierarchy of priority; and
adjusting the plurality of source locations in the 3D audio space for the plurality of audio sources based on the change in the hierarchy of priority.

6. The method of claim 1, further comprising:
assigning a hierarchy of priority to a plurality of audio sources of a plurality of message types;
defining a plurality of source locations in the 3D audio space to the plurality of audio sources;
assigning a plurality of volume levels to the plurality of audio sources based on the hierarchy of priority; and
projecting one or more audio messages for each of the plurality of audio sources from a corresponding source location and at a corresponding volume level.

7. The method of claim 1, further comprising:
determining a plurality of communicators generating the one or more audio messages of the first message type;
assigning a plurality of sub-source locations to the plurality of communicators, wherein each of the plurality of sub-source locations is offset from the source location to give directionality to the one or more audio messages from the plurality of communicators; and
projecting corresponding one or more audio messages from each of the plurality of communicators from a corresponding sub-source location.

8. The method of claim 1, further comprising:
determining a plurality of communicators generating the one or more messages of the first message type;
assigning a hierarchy of priority to the plurality of communicators;
assigning a plurality of volume levels to the plurality of communicators based on the hierarchy of priority; and
projecting corresponding one or more audio messages for each of the plurality of communicators at a corresponding volume level.

9. The method of claim 1, further comprising:
capturing using a receiver local communication from a communicator located in a physical space within which the 3D audio space is defined,
wherein the audio system includes a headset.

10. The method of claim 1, further comprising:
defining a 3D virtual reality space for the video game, wherein the 3D virtual space corresponds with the 3D audio space;
projecting a plurality of images from the game play of the video game via a head mounted display;
fixing the source location of the first audio source relative to the head mounted display, such that the source location relative to the head mounted display is the same for any orientation of the head mounted display in a physical space;
rotating the head mounted display to an orientation within the physical space;
translating the source location relative to the head mounted display to a new location in the 3D audio space based on the orientation of the head mounted display; and
projecting the one or more audio messages of the first audio source from the new location in the 3D audio space.

11. A computer system comprising:
a processor; and
memory coupled to the processor and having stored therein instructions that, if executed by the computer system, cause the computer system to execute a method comprising:
defining a three dimensional (3D) audio space for use by an audio system configured to provide localized sound with directionality in the 3D audio space;
localizing gaming audio from a game play of a video game within the 3D audio space using the audio system;
representing a first audio source providing audio of a first message type with an icon movable through a visual representation of the 3D audio space via a user interface;
detecting movement of the icon to a source location in the visual representation of the 3D audio space via the user interface;
assigning the source location to the first audio source based on a selection of the source location via the user interface; and
projecting one or more audio messages of the first audio source from the source location using the audio system.

12. The computer system of claim 11, the method further comprising:
detecting movement of the icon from the source location to a second location in the representation of the 3D audio space via the user interface;
assigning the second location to the first audio source based on a selection of the second location via the user interface; and
projecting the one or more audio messages of the first message type from the second location using the audio system.

13. The computer system of claim 11, the method further comprising:
assigning a hierarchy of priority to a plurality of audio sources of a plurality of message types;
assigning a plurality of source locations in the 3D audio space to the plurality of audio sources based on the hierarchy of priority;
detecting a change in the hierarchy of priority; and
adjusting the plurality of source locations in the 3D audio space for the plurality of audio sources based on the change in the hierarchy of priority.

14. The computer system of claim 11, the method further comprising:
assigning a hierarchy of priority to a plurality of audio sources of a plurality of message types;
defining a plurality of source locations in the 3D audio space to the plurality of audio sources;
assigning a plurality of volume levels to the plurality of audio sources based on the hierarchy of priority; and
projecting one or more audio messages for each of the plurality of audio sources from a corresponding source location and at a corresponding volume level.

15. The computer system of claim 11, the method further comprising:
determining a plurality of communicators generating the one or more audio messages of the first message type;
assigning a plurality of sub-source locations to the plurality of communicators, wherein each of the plurality of sub-source locations is offset from the source location to give directionality to the one or more audio messages from the plurality of communicators; and
projecting corresponding one or more audio messages from each of the plurality of communicators from a corresponding sub-source location.

16. The computer system of claim 11, the method further comprising:
determining a plurality of communicators generating the one or more messages of the first message type;
assigning a hierarchy of priority to the plurality of communicators;
assigning a plurality of volume levels to the plurality of communicators based on the hierarchy of priority; and
projecting corresponding one or more audio messages for each of the plurality of communicators at a corresponding volume level.

17. The computer system of claim 11, the method further comprising:
capturing using a receiver local communication from a communicator located in a physical space within which the 3D audio space is defined,
wherein the audio system includes a headset.

18. A non-transitory computer-readable medium storing a computer program for performing a method, the computer-readable medium comprising:
program instructions for defining a three dimensional (3D) audio space for use by an audio system configured to provide localized sound with directionality in the 3D audio space;
program instructions for localizing gaming audio from a game play of a video game within the 3D audio space using the audio system;
program instructions for representing a first audio source providing audio of a first message type with an icon movable through a visual representation of the 3D audio space via a user interface;
program instructions for detecting movement of the icon to a source location in the visual representation of the 3D audio space via the user interface;
program instructions for assigning the source location to the first audio source based on a selection of the source location via the user interface; and
program instructions for projecting one or more audio messages of the first audio source from the source location using the audio system.

19. The non-transitory computer-readable medium of claim 18, further comprising:
program instructions for detecting movement of the icon from the source location to a second location in the representation of the 3D audio space via the user interface;
program instructions for assigning the second location to the first audio source based on a selection of the second location via the user interface; and
program instructions for projecting the one or more audio messages of the first message type from the second location using the audio system.

20. The non-transitory computer-readable medium of claim 18, further comprising:
program instructions for determining a plurality of communicators generating the one or more audio messages of the first message type;
program instructions for assigning a plurality of sub-source locations to the plurality of communicators, wherein each of the plurality of sub-source locations is offset from the source location to give directionality to the one or more audio messages from the plurality of communicators; and
program instructions for projecting corresponding one or more audio messages from each of the plurality of communicators from a corresponding sub-source location.
